(19) United States
(12) Patent Application Publication
(10) Pub. No.: US 2025/0306252 A1
(43) Pub. Date: Oct. 2, 2025

(54) LIGHT TRANSMITTING SHEET

(71) Applicant: Panasonic Automotive Systems Co., Ltd., Kanagawa (JP)

(72) Inventors: Yuma SASAGAWA, Osaka (JP); Hideaki ETO, Osaka (JP)

(21) Appl. No.: 19/088,546

(22) Filed: Mar. 24, 2025

(30) Foreign Application Priority Data
Mar. 28, 2024 (JP) 2024-052751
Mar. 28, 2024 (JP) 2024-052752
Dec. 2, 2024 (JP) 2024-209768

(51) Int. Cl. G02B 5/20; G02B 5/00

(52) U.S. Cl. CPC G02B 5/20; G02B 5/005

(57) ABSTRACT

A light transmitting sheet according to the embodiment includes a base material layer, a design layer, and a colored layer. The base material layer transmits light. The design layer is provided to face a side of the base material layer irradiated with the light and having a light transmitting portion and a light shielding portion. The colored layer is provided to face the base material layer with the design layer interposed therebetween.

### CROSS-REFERENCE TO RELATED APPLICATIONS

This application is based upon and claims the benefit of priority from Japanese Patent Application No. 2024-052751, filed on Mar. 28, 2024, Japanese Patent Application No. 2024-052752, filed on Mar. 28, 2024 and Japanese Patent Application No. 2024-209768, filed on Dec. 2, 2024, the entire contents of which are incorporated herein by reference.

### FIELD

The present disclosure relates to a light transmitting sheet.

### BACKGROUND

Japanese Patent No. 6271135 discloses an artificial leather sheet having a laminated structure having light-transmittance.

However, in the conventional technique disclosed in Japanese Patent No. 6271135, there is room for improvement from the viewpoint of functionality, such as blurring of a design that is transmitted and appears and deterioration of visibility.

A non-limiting example of the present disclosure has an object to solve the above problems, and provide a light transmitting sheet having a highly visible design.

### SUMMARY

A light transmitting sheet according to the embodiment includes a base material layer, a design layer, and a colored layer. The base material layer transmits light. The design layer is provided to face a side of the base material layer irradiated with the light and having a light transmitting portion and a light shielding portion. The colored layer is provided to face the base material layer with the design layer interposed therebetween.

### BRIEF DESCRIPTION OF THE DRAWINGS

FIG. 1 is a schematic view illustrating a configuration of a light transmissive decoration system including a light transmitting sheet according to a first embodiment of the present disclosure;

FIG. 2 is a schematic view illustrating a configuration of the light transmissive decoration system including a light transmitting sheet in which concavity and convexity (irregularities) are formed on a base material layer according to the first embodiment of the present disclosure;

FIG. 3 is a front view of a design layer according to the first embodiment of the present disclosure;

FIG. 4 is a schematic cross-sectional view illustrating a configuration of the light transmissive decoration system including a light transmitting sheet provided with a color shift layer according to a first modification example of the first embodiment of the present disclosure;

FIG. 5 is a schematic view illustrating a configuration of the light transmissive decoration system including a light transmitting sheet in which a transmission hole is provided in a colored layer according to a second modification example of the first embodiment of the present disclosure;

FIG. 6 is a schematic view illustrating a configuration of a light transmissive decoration system including a light transmitting sheet provided with a protective layer according to a second embodiment of the present disclosure;

FIG. 7 is a schematic view illustrating a configuration of a light transmissive decoration system including a light transmitting sheet provided with a color shift layer according to a first modification example of the second embodiment of the present disclosure;

FIG. 8 is a schematic view illustrating a configuration of the light transmissive decoration system including a light transmitting sheet in which a transmission hole is provided in a colored layer according to a second modification example of the second embodiment of the present disclosure;

FIG. 9 is a schematic view illustrating a configuration of the light transmissive decoration system including a light transmitting sheet provided with a functional layer according to a fourth modification example of the second embodiment of the present disclosure;

FIG. 10 is a schematic view illustrating a configuration of the light transmissive decoration system including a light transmitting sheet in which a design layer is provided adjacent to a base material layer according to the second embodiment of the present disclosure;

FIG. 11 is a schematic view illustrating a configuration of the light transmissive decoration system including a light transmitting sheet in which a protective layer is colored and a colored layer is not included according to the second embodiment of the present disclosure;

FIG. 12 is a schematic view illustrating a configuration of a light transmissive decoration system including a light transmitting sheet provided with a reflection layer according to a third embodiment of the present disclosure;

FIG. 13 is a schematic view illustrating a configuration of the light transmissive decoration system including a light transmitting sheet of a first modification example of the third embodiment;

FIG. 14 is a schematic view illustrating a configuration of the light transmissive decoration system including a light transmitting sheet of a second modification example of the third embodiment;

FIG. 15 is a perspective view of a design layer of a light transmitting sheet according to the second modification example of the third embodiment; and

FIG. 16 is a schematic view illustrating a configuration of the light transmissive decoration system including a light transmitting sheet of a third modification example of the third embodiment.

### DETAILED DESCRIPTION

Hereinafter, preferred embodiments of the present disclosure will be described in detail with reference to the accompanying drawings. Note that, in the present specification and the drawings, components having substantially the same function are denoted by the same reference numerals, and redundant description is omitted.

### First Embodiment

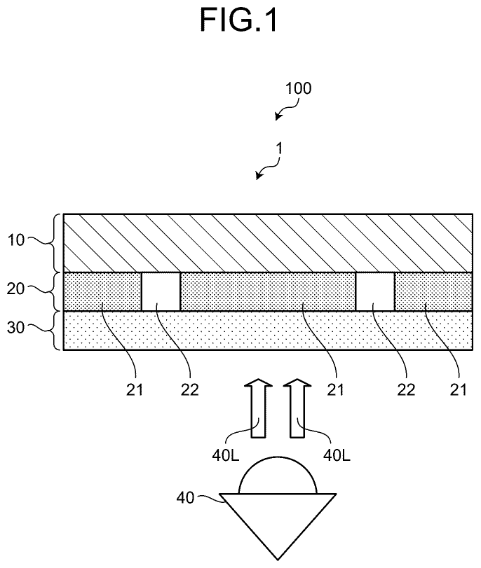

FIG. 1 is a schematic view of a light transmissive decoration system 100 including a light transmitting sheet 1 according to a first embodiment.

The light transmissive decoration system 100 includes the light transmitting sheet 1 and a light source 40. The light transmitting sheet 1 includes a base material layer 10, a design layer 20, and a colored layer 30. The base material layer 10, the design layer 20, and the colored layer 30 can be made of a sheet-like light transmitting material such as a resin film, a resin sheet, or a resin thin plate. Furthermore, it is possible to form the base material layer 10 from a sheet-like light transmitting material, and then bond the design layer 20 and the colored layer 30 to it, or to laminate them by a method such as printing.

The base material layer 10 is a portion serving as a support of the light transmitting sheet 1, and supports the design layer 20 and the colored layer 30. More specifically, the design layer 20 is provided on the back surface with the surface irradiated with light 40L from the light source 40 as the back surface of the base material layer 10 and the opposite side as the front surface, and the colored layer 30 is further provided on the side closest to the light source 40.

In addition, the base material layer 10 transmits the light 40L from the light source 40 and has elasticity. The material used for the base material layer 10 is not particularly limited, but is desirably an elastomer material capable of transmitting light 40L and having elasticity. The elastomer material is a polymer material that has elasticity and can be molded. Examples of the elastomer material include, but are not limited to, polyester, urethane, and silicon materials.

The thickness of the base material layer 10 is desirably a degree to which a flexible tactile sensation is given to the user. Specifically, it is desirably about 0.2 mm to 1.0 mm, but is not limited to this range. In addition, since it is desirable to have elasticity when pressure is applied, it is still more preferable that the thickness is 0.5 mm or more.

Further, since the base material layer 10 is required to have light-transmittance, it is desirable that the base material layer be transparent or translucent. As long as light of a predetermined amount of light can be transmitted, it may be colorless or colored. At this time, the transmittance of the base material layer 10 to the light 40L is preferably 50% or more.

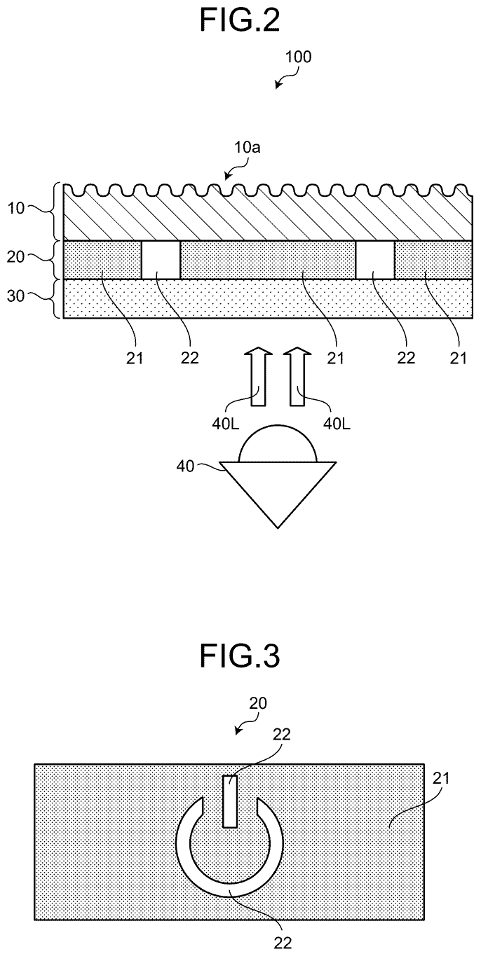

FIG. 2 is a schematic view illustrating a configuration of the light transmissive decoration system 100 including a light transmitting sheet in which concavity and convexity are formed on a base material layer 10 according to the first embodiment of the present disclosure. As illustrated in FIG. 2, concavity and convexity 10a may be provided on the surface of the base material layer 10. The concavity and convexity 10a are formed by irregularity processing. For example, by providing the irregularity 10a of the leather pattern on the base material surface, it is possible to give the user a leather-like appearance and tactile sensation. The shape of the irregularity 10a is not limited as long as the user can feel the decorativeness. For example, metal hairline processing, unevenness processing that gives a feeling of wood grain, and irregularity processing that gives a feeling of cloth may be performed.

In the case of design or irregularity processing that makes a user think of a material having hardness, such as hairline processing of metallic tone or wood grain processing, it is desirable to use a material having an elastic modulus (Young's modulus) corresponding to hardness corresponding to the appearance for the base material layer 10. Since the base material layer 10 has rigidity corresponding to an elastic modulus (Young's modulus) according to an appearance, it is possible to give a user a hard touch feeling based on a design and processing that makes a user feel a material providing a hard tactile sensation. At this time, as a material of the base material layer 10, polyethylene terephthalate, polycarbonate, or the like is conceivable, but the material is not limited thereto.

The method for forming the irregularity 10a on the surface of the base material layer 10 is not particularly limited as long as the concavity and convexity 10a can be formed on the surface of the base material layer 10, and examples thereof include thermal imprint transfer, an in-mold molding method, and a resin application method. For example, in a case where a thermal imprint transfer method is used, a mold having concavity and convexity to be formed on the surface is pressed against a semi-cured ultraviolet curable resin containing a hard coat material to transfer the shape, and ultraviolet rays are radiated with the mold being pressed, whereby the concavity and convexity 10a can be formed on the surface of the base material layer 10.

On the back surface of the base material layer 10, the design layer 20 is provided adjacent to the base material layer 10. That is, the design layer 20 is provided at a position closer to the base material layer 10 than the colored layer 30.

FIG. 3 is a front view of the design layer 20 according to an example of the embodiment. As illustrated in FIGS. 1 and 3, the design layer 20 includes a light shielding portion 21 that shields light and a light transmitting portion 22 that transmits light. The design layer 20 causes a design of characters, a figure, a pattern, an icon, or a combination thereof to appear in the shape of the light transmitting portion 22 as the light shielding portion 21 shields the light 40L from the light source 40. Note that the light shielding portion 21 may form a design of a character, a figure, a pattern, an icon, or a combination thereof, and the shape of the light shielding portion 21 may appear on the surface as the light transmitting portion 22 transmits light.

It is conceivable that the design layer 20 be provided on the back surface of the base material layer 10 using a screen printing technique in which an ink is placed on a screen in which a portion (light transmitting portion 22) unnecessary for printing is solidified with an emulsion and the ink (light shielding portion 21) is transferred by rubbing with a squeegee. However, the present invention is not limited thereto. For example, the light transmitting portion 22 may be provided in a part by irradiating a film partially cut out in a design shape or a coated sheet member such as a coated film or a coated plate with a laser to form an opening (hole).

Since the design layer 20 is provided between the base material layer 10 and the colored layer 30, the light 40L emitted from the light source 40 passes through the colored layer 30, the design layer 20, and the base material layer 10 in this order. That is, the light 40L that has passed through the light transmitting portion 22 is not affected by the light diffusibility of the colored layer 30.

On the other hand, in a case where the design layer 20 is laminated closer to the light source 40 than the colored layer 30, the light 40L of the light source 40 passes through the design layer 20, the colored layer 30, and the base material layer 10 in this order. In this case, the light that has passed through the light transmitting portion 22 passes through the colored layer 30 and is affected by the light diffusibility of the colored layer 30, so that the contour of the design that should have been displayed on the surface of the light transmitting sheet 1 by passing through the light transmitting portion 22 may become unclear.

Therefore, in the first embodiment, by laminating the design layer 20 closer to the base material layer 10 than the colored layer 30, in other words, by providing the design layer 20 between the base material layer 10 and the colored layer 30, the light 40L that passes through the light transmitting portion 22 is affected by the light diffusibility of the colored layer 30, which prevents the outline of the design from becoming unclear, thereby improving the visibility and designability of the design.

At this time, the transmittance of the light 40L of the light shielding portion 21 of the design layer 20 is preferably 5% or less. This is because the light shielding portion 21 does not transmit the light 40L, so that the design of the shape of the light transmitting portion 22 or the shape of the light shielding portion 21 appears on the sheet surface.

As described above, the colored layer 30 is provided on the back surface side of the design layer 20. That is, the colored layer 30 is provided to face the base material layer 10 with the design layer 20 interposed therebetween. The colored layer 30 is light-transmittance and has a coloring function of coloring the light transmitting sheet 1. In addition, the colored layer 30 also has a function of making a boundary or the like between the light transmitting portion 22 and the light shielding portion 21 of the design layer 20 inconspicuous.

It is conceivable that the colored layer 30 is formed by screen printing similarly to the design layer 20 described above, but the present invention is not limited thereto. For example, it is conceivable to use smoke coating or a smoke film.

In FIGS. 1 to 3 and the subsequent drawings, for example, as in a case where a colored layer 30 formed as a resin film is bonded to a design layer 20 formed as a resin film, this shows a state in which even if the colored layer 30 is formed on the light transmitting portion 22 of the design layer 20, the colored layer 30 does not affect the light transmitting portion 22.

However, when the design layer 20 is formed, in a case where the light shielding portion 21 is formed by screen printing, in a case where the light transmitting portion 22 is formed by cutting out a part of the light-shielding resin film, or the like, for example, when the colored layer 30 is formed by printing, a part of the colored layer 30 may actually enter a portion corresponding to the light transmitting portion 22, but the substantial function is not affected. Therefore, in the present disclosure, as illustrated in FIGS. 1 to 3 and the following drawings, a description will be given as a schematic view illustrating a state where the colored layer 30 does not affect the light transmitting portion 22.

In addition, the colored layer 30 is formed such that at least a color of a portion facing the light transmitting portion 22 has a color close to that of the light shielding portion 21.

Here, examples of a state in which the “colors are similar” include a state in which lightness and saturation are different in the same hue in the PCCS hue wheel. Alternatively, in the PCCS hue wheel, hues are numbered from 1 to 24, and in a case where the number of the hue of the colored layer 30 is a number different from the number of the hue of the light shielding portion 21 by about 1 to 3, it can be said to be in a state in which colors are similar. The PCCS hue wheel is a color system developed by Japan Color Research Institute.

For example, in a case where the light shielding portion 21 is yellow with the hue number=8, if the colored layer 30 is reddish yellow with the hue number=7, the colors are similar.

Furthermore, a state in which the colors are similar can also be expressed as a state in which the color difference is small. The color difference is an index representing a difference between two colors or colors of an object, and refers to, for example, a distance between coordinates of two colors when colors of two objects are applied to color coordinates in a three-dimensional color space such as an L*a*b color space, an RGB color space, and an XYZ color space. The color difference in each color space is determined by a color difference formula defined by the International Commission on Illumination (CIE). The state in which the colors are similar is a state in which a color difference is small and it is difficult to identify a color difference.

At this time, assuming that the color difference between the design layer 20 and the colored layer 30 in each color space is ΔE, the color difference between the design layer 20 and the colored layer 30 is preferably ΔE≤5.0. Preferably, ΔE≤3.0. More preferably, ΔE≤1.5. Since the color difference between the light shielding portion 21 and the colored layer 30 is smaller, it is possible to further suppress the design of the design layer 20 from being seen through in a state where the light 40L is not emitted from the light source 40, and stealth property can be obtained.

At least the color of the portion of the colored layer 30 facing the light transmitting portion 22 may be formed so that the color difference ΔE from the color of the light shielding portion 21 becomes small. Since the color of the portion of the colored layer 30 facing the light transmitting portion 22 and the color tone of the light shielding portion 21 are similar to each other, an effect of making the boundary between the light transmitting portion 22 and the light shielding portion 21 of the design layer 20 inconspicuous in a case where the light source 40 does not emit the light 40L can be obtained. At this time, a portion of the colored layer 30 not in contact with the light transmitting portion 22, in other words, a portion not facing the light transmitting portion 22 may not be formed to have a similar color. A portion of the colored layer 30 not in contact with the light transmitting portion 22 may not have a function as the colored layer 30. That is, it may not have translucency or may be colorless.

In addition, the transmittance of the light 40L of the colored layer 30 is preferably 50% or more.

In addition, between the base material layer 10 and the design layer 20, and between the design layer 20 and the colored layer 30, a layer (for example, an adhesive layer, a reinforcing layer, and the like) having another function that does not inhibit the original function of the light transmitting sheet 1 may be disposed. Also in this case, in order to clarify the contour of the design, the order of lamination of the base material layer 10, the design layer 20, and the colored layer 30 may be the colored layer 30, the design layer 20, and the base material layer 10 in the order in which the light 40L emitted from the light source 40 passes.

### First Modification Example

In the first modification example, the light transmitting sheet 1 differs from the light transmitting sheet 1 of the first embodiment in that it has a color shifting layer 50.

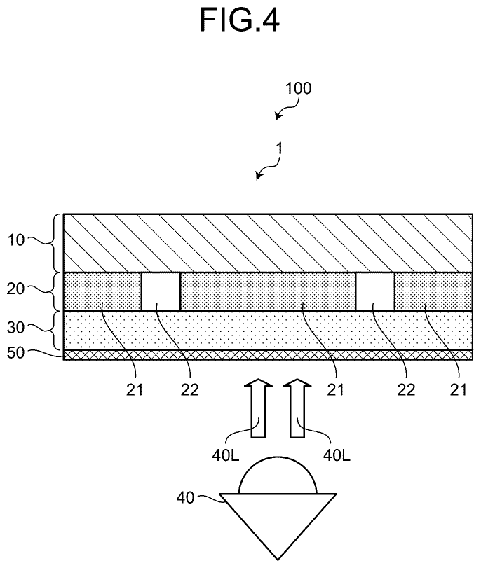

FIG. 4 is a schematic cross-sectional view illustrating a configuration of the light transmissive decoration system 100 including the light transmitting sheet 1 provided with a color shifting layer 50 according to a first modification example of the first embodiment of the present disclosure. The color shifting layer 50 is provided on the light source 40 side (back surface side of the colored layer 30) of the colored layer 30. Since the color shifting layer 50 is provided at the position closest to the light source 40, the color of the colored layer 30 when viewed from the front surface side of the base material layer 10 is hardly affected. The color shifting layer 50 may be provided between the colored layer 30 and the design layer 20 or between the design layer 20 and the base material layer 10. The arrangement place is not limited as long as it is not closer to the front surface side of the light transmitting sheet 1 than the base material layer 10.

The color shifting layer 50 has translucency and has a function of changing the color of light. In a case where the color shifting layer 50 is not provided, the color of the light 40L emitted from the light source 40 may change when passing through the colored layer 30. For example, in a case where the color of the light 40L to be displayed on the surface is green, if the colored layer 30 is yellow, even if the light 40L of the light source 40 is made green, the color displayed on the surface may be mixed and become a color different from green.

On the other hand, according to the color shifting layer 50, for example, when the color of the light 40L emitted from the light source 40 by passing through the colored layer 30 is changed, the color tone of the light transmitted to the surface of the base material layer 10 can be brought close to the color tone of the light emitted from the original light source 40 by shifting the color of the light through the color shifting layer 50. For example, in a case where the color of the light 40L to be displayed on the surface is white, if the colored layer 30 is yellow, a blue-green may be used as the color shifting layer 50.

Note that, as a material of the color shifting layer 50, a color filter that passes only light of a specific color tone, a color film, or the like is conceivable. Note that the material and method are not limited thereto as long as the color of the light source 40 can be changed.

### Second Modification Example

In the second modification example, the colored layer 30 of the light transmitting sheet 1 differs from the light transmitting sheet 1 of the first embodiment in that it has transmission holes 30a.

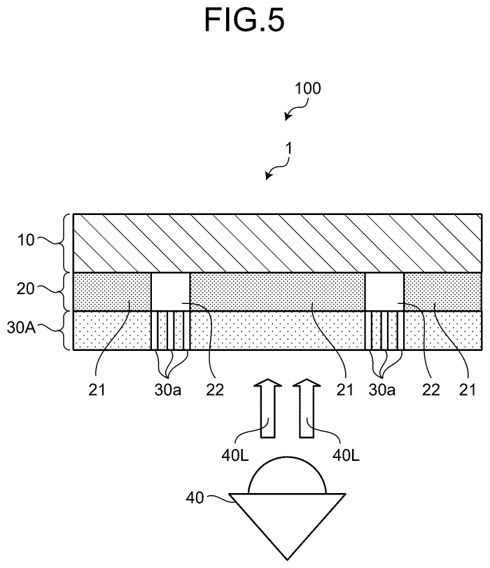

FIG. 5 illustrates a schematic view indicating a configuration of the light transmissive decoration system 100 including the light transmitting sheet 1 in which the transmission holes 30a are provided in a colored layer 30A according to a second modification example of the first embodiment of the present disclosure.

The transmission hole 30a is provided to transmit light to the light transmitting portion 22 of the design layer 20 while suppressing the influence of the colored layer 30 on the light of the light source 40, and may be provided at least at a portion facing the light transmitting portion 22.

At this point, the hole diameter of the transmission hole 30a is made smaller than the width of the light transmitting portion 22. More preferably, a plurality of fine dotted transmission holes 30a that cannot be determined with the naked eye may be provided. Due to the presence of the transmission hole 30a, light passing through the light transmitting portion 22 is divided into light passing through the colored layer 30 and light passing through the transmission hole 30a. The color of the light passing through the colored layer 30 changes under the influence of the color of the colored layer 30, but at the same time, the intensity and energy of the light are attenuated by the colored layer 30.

On the other hand, since the light passing through the transmission hole 30a does not pass through the main body portion of the colored layer 30 functioning as a color filter (portion where the transmission hole 30a is not formed) or the light shielding portion 21 (for example, ink), the intensity and energy of the light become larger than those of the light passing through the main body portion of the colored layer 30. Therefore, the light passing through the transmission hole 30a appears to be more dominant than the light passing through the colored layer 30. As a result, it is possible to suppress the change in the color of the light 40L radiated by the light source 40 due to the colored layer 30. Thus, the color change of the light source 40 can be suppressed without impairing the sheet coloring and stealth property of the colored layer 30.

### Third Modification Example

In the third modification example, it differs from the light transmissive decoration system 100 of the first embodiment in that the color of the light 40L of the light source 40 is set by calculating backwards from the color of the colored layer 30.

As described in the first modification example, the color of the light 40L emitted from the light source 40 may change when passing through the colored layer 30.

In the third modification example, the color of the light 40L of the light source 40 is set to emit a target color by shifting the color in the colored layer 30. That is, the color of the light source 40 is set by calculating backward from the target color when the light 40L appears on the surface and the change rate of the chromaticity coordinate by the colored layer 30. The color of the light 40L of the light source 40 is changed by the colored layer 30, so that the light becomes a target color when appearing on the surface.

For example, in a case where it is desired to transmit green to the sheet surface, but the colored layer 30 is blue, the color of the light 40L of the light source 40 is set in advance to be yellow, so that the color of the light 40L appearing on the sheet surface becomes green.

The color of the light source 40 may be set from the material of the colored layer 30 and the optical characteristics of the color. For example, in a case where the colored layer 30 is a brown filter, since the brown filter absorbs blue light and passes through red and green, yellow emerges on the surface by setting the color of the light source 40 to white light.

Thus, the color of the light 40L of the light source 40 transmitted through the sheet surface can be prevented from being different from the target color due to the influence of the colored layer 30.

### Fourth Modification Example

In the fourth modification example, the light transmitting sheet 1 is different from the light transmitting sheet of the first embodiment in that a functional layer 68 is provided between layers.

As the functional layer 68, for example, an ultraviolet ray cutting layer, an adhesive layer for enhancing adhesion of each layer, and the like can be considered. The functional layer 68 can be formed using a general printing technique (screen printing, resin application method, or the like). For example, in the case of the ultraviolet ray cutting layer, an effect of suppressing deterioration of the light transmitting sheet 1 can be expected. Furthermore, if the functional layer 68 is an adhesive layer, for example, in a case where the design layer 20 and the like are provided by an ink printing technique, it is possible to prevent the ink from peeling off or appearing floating because the ink does not have very good adhesion. Note that the functional layer 68 may be disposed closest to the light source 40 side.

### Configuration and Effect of First Embodiment

Hereinafter, the configuration of the first embodiment and the effects thereof will be described.

The light transmitting sheet 1 according to the first embodiment of the present disclosure includes the base material layer 10 that transmits light, the design layer 20 that is provided on a back surface side of the base material layer 10 irradiated with light and includes the light shielding portion 21 and the light transmitting portion 22, and the colored layer 30 that is provided on the design layer 20 to face the base material layer 10 with the design layer 20 interposed therebetween and adjusts an overall color, in which the colored layer 30 is configured such that the color of at least a portion facing the light transmitting portion 22 is close to the color of the light shielding portion 21.

According to the above configuration, since the colored layer 30 is configured so that the color of at least the portion facing the light transmitting portion 22 becomes similar to the color of the light shielding portion 21, the light passing through the light transmitting portion 22 is not affected by the light diffusibility by the colored layer 30, the design is suppressed from being blurred when viewed from the sheet surface, and the designability and the visibility of the design can be improved. Therefore, the user can obtain visual beauty, and can ascertain information accurately and quickly by clearly visually recognizing a design including information such as characters and symbols.

In addition, the light transmitting sheet 1 can prevent a design from appearing in a case where the light 40L is not radiated, and can also obtain stealth property. Therefore, it is possible to prevent the user from erroneously recognizing that the design is displayed, and to appropriately present information to the user. In addition, since the design is not seen while the light is not transmitted, the decorative sheet is made to look like a woodgrain pattern, a leather pattern, or the like, so that the user can feel an aesthetic appearance.

In addition, in the light transmitting sheet 1, the colored layer 30 is configured such that the color difference of the light shielding portion 21 is equal to or less than a predetermined value.

According to this configuration, since the color difference between the colored layer 30 and the light shielding portion 21 is configured to be equal to or less than the predetermined value, it is possible to prevent the design from appearing and being viewed when the light 40L is not radiated, and to obtain stealth property. Therefore, it is possible to further suppress the possibility that the user misrecognizes the information. In addition, it is possible to prevent the design from appearing and disturbing the pattern of the leather and the like in a case where the light 40L is not radiated, thereby impairing the aesthetic appearance.

In addition, in the light transmitting sheet 1, the colored layer 30 is configured such that the color difference from the light shielding portion 21 is ΔE≤5.0.

According to this configuration, since the colored layer 30 is configured such that the color difference from the light shielding portion 21 is ΔE≤5.0, it is possible to prevent the design from appearing and to obtain stealth property in a case where the light 40L is not radiated. Therefore, it is possible to further suppress the possibility that the user misrecognizes the information. In addition, it is possible to suppress that the design appears in a case where the light 40L is not radiated, and the appeared design visually interferes with the leather pattern or the like, thereby impairing the aesthetic appearance.

In addition, in the light transmitting sheet 1, the colored layer 30 is configured such that the color difference from the light shielding portion 21 is ΔE≤3.0.

According to this configuration, since the colored layer 30 is configured such that the color difference from the light shielding portion 21 is ΔE≤3.0, it is possible to further suppress the design from appearing when the light 40L is not radiated. Therefore, it is possible to further suppress the possibility that the user misrecognizes the information. In addition, it is possible to further suppress that the design appears in a case where the light 40L is not radiated, and the appeared design visually interferes with the leather pattern or the like, thereby impairing the aesthetic appearance.

In addition, in the light transmitting sheet 1, the colored layer 30 is configured such that the color difference from the light shielding portion 21 is ΔE≤1.5.

According to this configuration, since the colored layer 30 is configured such that the color difference from the light shielding portion 21 is ΔE≤1.5, it is possible to further suppress the design from appearing when the light 40L is not radiated. Therefore, it is possible to further suppress the possibility that the user misrecognizes the information. In addition, it is possible to still further suppress that the design appears in a case where the light 40L is not radiated, and the appeared design visually interferes with the leather pattern or the like, thereby impairing the aesthetic appearance.

Furthermore, in the light transmitting sheet 1, a surface irradiated with the light 40L from the light source 40 that emits light is set as a back surface of the base material layer 10, and the color shifting layer 50 for correcting the color of the light 40L is further provided on the back surface side of the base material layer 10.

According to this configuration, since the color shifting layer 50 for correcting the color of the light 40L is provided on the back surface side of the base material layer 10, the color of the light 40L displayed on the sheet surface changed by the influence of the colored layer 30 can be corrected by the color shifting layer 50. Therefore, by displaying the color of the light 40L more accurately, the user can appropriately interpret the information obtained through the color.

In addition, in the light transmitting sheet 1, the transmission hole 30a that transmits light is provided in a portion facing the light transmitting portion 22 of the design layer 20, and the transmission hole 30a has a hole diameter smaller than a width of the light transmitting portion 22.

According to this configuration, since the small transmission hole 30a is opened in the portion of the colored layer 30 facing the light transmitting portion 22 of the design layer 20, the portion of the light 40L passing through the transmission hole 30a is not affected by the colored layer 30, and the transmission hole 30a has a hole diameter smaller than the width of the light transmitting portion 22, so that stealth property can be maintained. Therefore, in a case where the light 40L is not radiated, the design does not appear, and the possibility that the user misrecognizes the information is suppressed. In a case where the light 40L is radiated, the color of the light 40L is accurately displayed, and the intensity of the light 40L is not impaired, so that the user can accurately recognize the design and the information indicated by the design.

In addition, in the light transmitting sheet 1, the light shielding portion 21 has a transmittance of the light 40L of 5% or less.

According to this configuration, since the light shielding portion 21 has a transmittance of the light 40L of 5% or less, the light shielding portion 21 hardly passes the light 40L. Therefore, the design can appear in the shape of the light transmitting portion 22, and the user can more accurately recognize the shape of the design.

In addition, in the light transmitting sheet 1, the colored layer 30 has a transmittance of the light 40L of 50% or more.

According to this configuration, since the colored layer 30 has a transmittance of light 40L of 50% or more, the colored layer 30 effectively passes the light 40L, and thus the design of the light transmitting sheet 1 can be made to appear on the sheet surface with the light 40L.

In addition, in the light transmitting sheet 1, the base material layer 10 has concavity and convexity 10a on the surface.

According to this configuration, the light transmitting sheet 1 can obtain an appearance and a tactile sensation of a design having an irregularity shape such as a woodgrain pattern, leather, and hairline processing, and the design property is improved. Therefore, the user can feel an aesthetic appearance.

In addition, in the light transmitting sheet 1, the base material layer 10 is an elastomer sheet.

According to this configuration, since the base material layer 10 is an elastomer sheet, the light transmitting sheet 1 can obtain elasticity, and can be used for a member to which pressure is applied.

Furthermore, in the light transmissive decoration system 100, the color of the light 40L of the light source 40 is set to emit a target color by shifting the color in the colored layer 30.

According to this configuration, since the color of the light 40L of the light source 40 is set in consideration of the influence of the color received by the colored layer 30, the design can be displayed in a target color on the surface of the sheet as a result of the light 40L passing through the colored layer 30. Therefore, by displaying the color accurately, the user can appropriately interpret the information obtained through the color.

### Second Embodiment

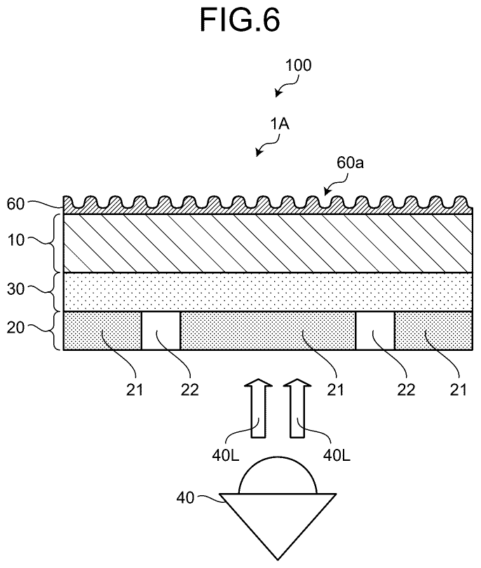

FIG. 6 is a schematic view illustrating a configuration of the light transmissive decoration system 100 including a light transmitting sheet 1A provided with a protective layer according to a second embodiment of the present disclosure. The present embodiment is different from the first embodiment in that a protective layer 60 is provided.

In the second embodiment, the same or equivalent configurations as those of the first embodiment will be described with the same reference numerals. In addition, in the second embodiment, the description overlapping with the first embodiment may be omitted.

The light transmitting sheet 1A according to the second embodiment includes the base material layer 10 that transmits light and has elasticity. With the surface on the light source 40 side as the back surface of the base material layer 10 and the opposite side as the front surface of the base material layer 10, the protective layer 60 for reinforcing at least one of abrasion resistance, hardness, light resistance, and chemical resistance of the base material layer 10 is provided on the front surface side of the base material layer 10.

At least a part of the surface of the protective layer 60 is subjected to irregularity processing. The colored layer 30 is provided on the back surface side of the base material layer 10, and the design layer 20 is provided on the outermost layer which is the back surface side of the colored layer 30.

The protective layer 60 is formed of a material that supplements at least one performance of the abrasion resistance, hardness, light resistance, and chemical resistance of the base material layer 10.

Meanwhile, the base material layer 10 is required to have elasticity and be flexible, and it is preferable to use an elastomer material. However, in a case where an elastomer material is used, due to its material properties, it may not be suitable for practical use in terms of abrasion resistance and the like in order to be used for interior of a vehicle or the like.

At this time, for example, the protective layer 60 is made of a material having higher abrasion resistance than the base material layer 10. By providing the protective layer 60 formed of a material having higher abrasion resistance than the base material layer 10, it is possible to obtain necessary and sufficient abrasion resistance when used for in-vehicle interior, and it can be put to practical use. As described above, for example, when the light transmitting sheet 1A is mounted as an interior material of a vehicle, even in a case where it is difficult to achieve reliability in some items due to the material properties of the base material layer 10, the reliability can be secured and improved by providing the protective layer 60.

The protective layer 60 preferably has elasticity, and is formed of, for example, a resin such as an acrylic resin or a polyester resin. Note that the protective layer 60 desirably has a structure containing a hard coat material. Examples of the hard coat material include, but are not limited to, a ceramic material and a chromium material. In addition, the protective layer 60 may be formed of a hard coat material having no elasticity.

The thickness of the protective layer 60 is preferably 0.05 mm or more and 0.5 mm or less. In addition, at this time, the thickness of the base material layer 10 is preferably 0.5 mm or more. The base material layer 10 is provided on the back surface side of the protective layer 60, and the protective layer 60 is thinner than the base material layer 10, so that an elastic tactile sensation utilizing the elasticity of the base material layer 10 can be obtained.

The surface of the protective layer 60 has concavity and convexity 60a, and concavity and convexity are imparted to the surface of the light transmitting sheet 1A. As a result, the light transmitting sheet 1A can obtain a quality as a design having an irregularity shape such as a leather pattern or a woodgrain pattern. Further, since the protective layer 60 has the concavity and convexity 60a on the surface, the surface of the base material layer 10 can be made smooth.

On the other hand, in a case where the surface of the base material layer 10 has concavity and convexity, and a hard coat is provided on the surface, it is necessary to adopt a method of directly forming the protective layer 60 on the surface in accordance with the concavity and convexity of the base material layer 10 or to form and bond the protective layer 60 in accordance with the concavity and convexity of the base material layer 10. However, in this case, there is a possibility that adhesion between the protective layer 60 and the base material layer 10 is poor. By forming the concavity and convexity 60a on the surface of the protective layer 60 and smoothing the base material layer 10, adhesion is improved and durability is improved.

The method for forming the concavity and convexity 60a on the surface of the protective layer 60 is not particularly limited as long as the concavity and convexity 60a can be formed on the surface of the protective layer 60, and examples thereof include thermal imprint transfer. For example, in a case where the thermal imprint transfer method is used, a mold having concavity and convexity to be formed on the surface is pressed against a semi-cured ultraviolet curable resin containing a hard coat material to transfer the shape, and ultraviolet rays are radiated with the mold being pressed, whereby the concavity and convexity 60a can be formed on the surface of the protective layer 60. In addition, an in-mold molding method, screen printing using a paste-like resin, and the like are considered.

In addition, the transmittance of the light 40L of the light source 40 in the protective layer 60 is preferably 50% or more. The protective layer 60 is formed of a colorless and transparent material. As a result, the design by the design layer 20 and the colored layer 30 can be displayed as it is on the surface of the light transmitting sheet 1A. Note that the color of the protective layer 60 is not limited as long as it has high translucency and does not cover the design appearing on the surface of the light transmitting sheet 1A by the design layer 20 and the colored layer 30 even if it is colored.

As illustrated in FIG. 6, in the light transmitting sheet 1A according to the second embodiment, the colored layer 30 is provided adjacent to the back surface side of the base material layer 10. That is, the colored layer 30 is provided on the back surface side of the base material layer 10 at a position closer to the base material layer 10 than the design layer 20. Furthermore, the design layer 20 is provided on a surface opposite to the surface in contact with the base material side of the colored layer 30. As a result, in a case where the surface of the light transmitting sheet 1A is colored by the colored layer 30 and the power source of the light source 40 is turned off, it is possible to have stealth property that makes the boundary between the light shielding portion 21 and the light transmitting portion 22 of the design layer 20 inconspicuous.

### First Modification Example

Similarly to the first modification example of the first embodiment, the light transmitting sheet 1A according to the present modification is different from that of the second embodiment in that the light transmitting sheet 1A includes the color shifting layer 50. In the present modification example, the design layer 20 and the colored layer 30 are laminated in this order from the back surface side of the base material layer 10.

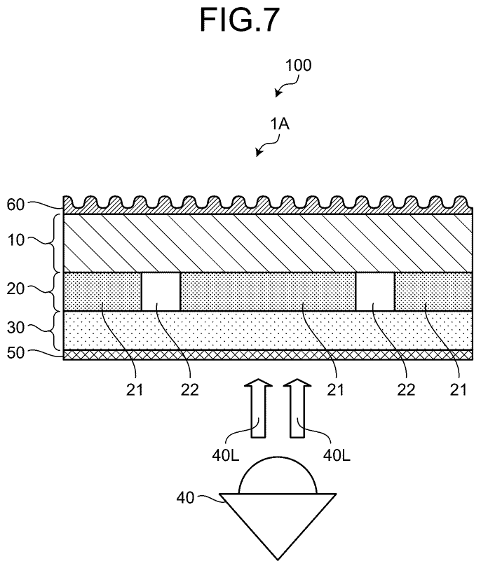

FIG. 7 is a schematic view illustrating a configuration of the light transmissive decoration system 100 including the light transmitting sheet 1A provided with the color shifting layer 50 according to a first modification example of the second embodiment of the present disclosure.

The color shifting layer 50 is provided on the light source 40 side (back surface side of the colored layer 30) of the colored layer 30. Since the color shifting layer 50 is provided at the position closest to the light source 40, the color of the colored layer 30 when viewed from the surface side of the base material layer 10 is hardly affected. The color shifting layer 50 may be provided between the colored layer 30 and the design layer 20 or between the design layer 20 and the base material layer 10. The arrangement place is not limited as long as it is not closer to the front surface side of the light transmitting sheet 1 than the base material layer 10.

The color shifting layer 50 has translucency and has a function of changing the color of light. In a case where the color shifting layer 50 is not provided, the color of the light 40L emitted from the light source 40 may change when passing through the colored layer 30. For example, in a case where the color of the light 40L to be displayed on the surface is green, if the colored layer 30 is yellow, even if the light 40L of the light source 40 is made green, the color displayed on the surface may be mixed and become a color different from green.

On the other hand, according to the color shifting layer 50, for example, when the color of the light 40L emitted from the light source 40 is charged by passing through the colored layer 30, the color tone of the light transmitted to the surface of the base material layer 10 can be brought close to the color tone of the light emitted from the original light source 40 by shifting the color of the light through the color shifting layer 50. For example, in a case where the color of the light 40L to be displayed on the surface is white, if the colored layer 30 is yellow, a blue-green may be used as the color shifting layer 50.

Note that, as a material of the color shifting layer 50, a color filter that passes only light of a specific color tone, a color film, or the like is conceivable. Note that the material and method are not limited thereto as long as the color of the light source 40 can be changed.

### Second Modification Example

Similarly to the second modification of the first embodiment, the colored layer 30 according to the present modification example is different from the second embodiment in including the transmission hole 30a. Also in the present modification example, as in the first modification example of the second embodiment, an example in which the design layer 20 and the colored layer 30 are laminated in this order from the back surface side of the base material layer 10 is shown.

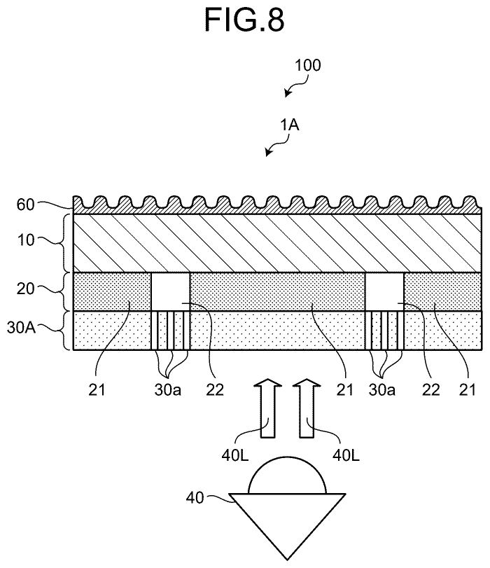

FIG. 8 is a schematic view illustrating a configuration of the light transmissive decoration system 100 including the light transmitting sheet 1A in which the transmission hole 30a is provided in the colored layer 30A according to a second modification example of the second embodiment of the present disclosure.

The transmission hole 30a is provided to transmit light to the light transmitting portion 22 of the design layer 20 while suppressing the influence of the colored layer 30 on the light of the light source 40, and may be provided at least at a portion facing the light transmitting portion 22.

At this point, the hole diameter of the transmission hole 30a is made smaller than the width of the light transmitting portion 22. More preferably, a plurality of fine dotted transmission holes 30a that cannot be determined with the naked eye may be provided. Due to the presence of the transmission hole 30a, light passing through the light transmitting portion 22 is divided into light passing through the colored layer 30 and light passing through the transmission hole 30a. The color of the light passing through the colored layer 30 changes under the influence of the color of the colored layer 30, but at the same time, the intensity and energy of the light are attenuated by the colored layer 30.

On the other hand, since the light passing through the transmission hole 30a does not pass through the main body portion of the colored layer 30 functioning as a color filter (portion where the transmission hole 30a is not formed) or the light shielding portion 21 (for example, ink), the intensity and energy of the light become larger than those of the light passing through the main body portion of the colored layer 30. Therefore, the light passing through the transmission hole 30a appears to be more dominant than the light passing through the colored layer 30. As a result, it is possible to suppress the change in the color of the light 40L radiated by the light source 40 due to the colored layer 30. Thus, the color change of the light source 40 can be suppressed without impairing the sheet coloring and stealth property of the colored layer 30.

### Third Modification Example

Similarly to the third modification example of the first embodiment, it is different from the light transmissive decoration system 100 of the second embodiment in that the color of the light 40L of the light source 40 is set by being inversely calculated from the color of the colored layer 30.

As described in the first modification example, the color of the light 40L emitted from the light source 40 may change when passing through the colored layer 30.

In the third modification example, the color of the light 40L of the light source 40 is set to emit a target color by shifting the color in the colored layer 30. That is, the color of the light source 40 is set by calculating backward from the target color when the light 40L appears on the surface and the change rate of the chromaticity coordinate by the colored layer 30. The color of the light 40L of the light source 40 is changed by the colored layer 30, so that the light becomes a target color when appearing on the surface.

For example, in a case where it is desired to transmit green to the surface of the light transmitting sheet 1A, but the colored layer 30 is blue, the color of the light 40L of the light source 40 is set in advance to be yellow, so that the color of the light 40L appearing on the surface of the light transmitting sheet 1A becomes green.

The color of the light source 40 may be set from the material of the colored layer 30 and the optical characteristics of the color. For example, in a case where the colored layer 30 is a brown filter, since the brown filter absorbs blue light and passes through red and green, yellow emerges on the surface by setting the color of the light source 40 to white light.

As a result, it is possible to prevent the color of the light 40L of the light source 40 transmitted through the surface of the light transmitting sheet 1A from being different from the target color due to the influence of the colored layer 30.

### Fourth Modification Example

Similarly to the fourth modification example of the first embodiment, the light transmitting sheet 1A is different from the second embodiment in that the functional layer 68 is provided between layers. Unlike the first modification example (FIG. 7) and the second modification example (FIG. 8) of the second embodiment, the present modification example shows an example in which the colored layer 30 and the design layer 20 are laminated in this order from the back surface side of the base material layer 10 as in the second embodiment (FIG. 6).

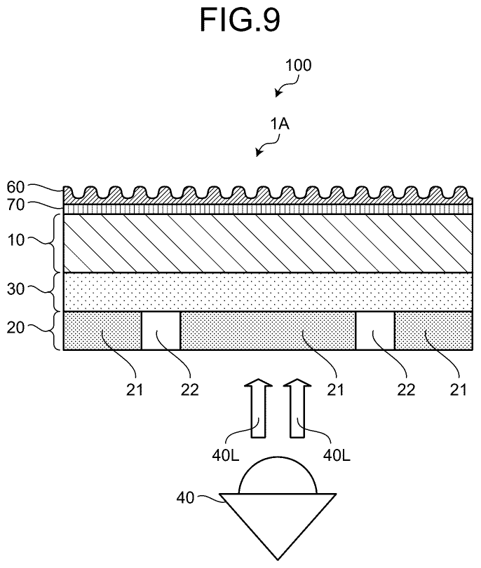

FIG. 9 is a schematic view illustrating a configuration of the light transmissive decoration system 100 including the light transmitting sheet 1A provided with the functional layer 68 according to the fourth modification example of the second embodiment of the present disclosure. As the functional layer 68, for example, an ultraviolet ray cutting layer, an adhesive layer for enhancing adhesion of each layer, and the like can be considered. The functional layer 68 can be formed using a general printing technique (screen printing, resin application method, or the like). For example, in the case of the ultraviolet ray cutting layer, an effect of suppressing deterioration of the light transmitting sheet 1A can be expected. Furthermore, if the functional layer 68 is an adhesive layer, for example, in a case where the design layer 20 and the like are provided by an ink printing technique, it is possible to prevent the ink from peeling off or appearing floating because the ink does not have very good adhesion.

### Fifth Modification Example

The fifth modification example is different from the second embodiment in that the order of lamination of the colored layer 30 and the design layer 20 is reversed.

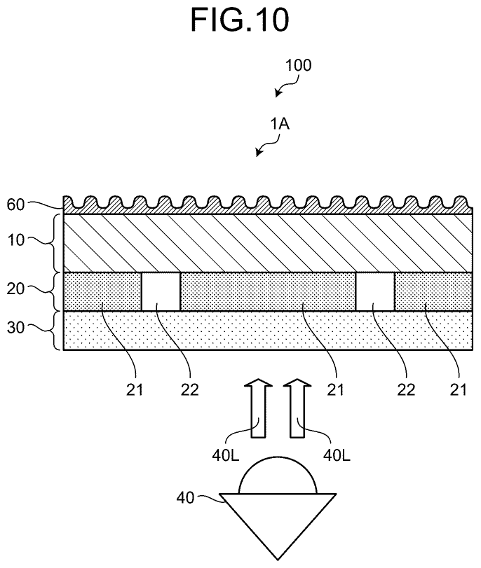

FIG. 10 is a schematic view illustrating a configuration of the light transmissive decoration system 100 including the light transmitting sheet 1A in which the design layer 20 is provided adjacent to the base material layer 10 according to the second embodiment of the present disclosure.

As illustrated in FIG. 10, the design layer 20 is provided on the back surface side of the base material layer 10, and the colored layer 30 is provided on the back surface side of the design layer 20. That is, the design layer 20 is provided at a position closer to the base material layer 10 than the colored layer 30. Thus, the order in which the light 40L radiated from the light source 40 passes is the colored layer 30, the design layer 20, and the base material layer 10. That is, since the light having passed through the light transmitting portion 22 of the design layer 20 is not affected by the light diffusibility of the colored layer 30, it is possible to suppress a state in which the contour of the design appears unclear.

However, when the design layer 20 is provided adjacent to the base material layer 10, the colored layer 30 does not cover the design layer 20, and there may be a problem that the boundary between the light shielding portion 21 and the light transmitting portion 22 is visible and the design emerges.

In view of the above problem, in the fifth modification example, the colored layer 30 is formed such that at least a color of a portion facing the light transmitting portion 22 has a color close to that of the light shielding portion 21. Examples of a state in which the “colors are similar” include a state in which lightness and saturation are different in the same hue in the PCCS hue wheel. Alternatively, in the PCCS hue wheel, hues are numbered from 1 to 24, and in a case where the number of the hue of the colored layer 30 is a number different from the number of the hue of the light shielding portion 21 by about 1 to 3, it can be said to be in a state in which colors are similar. The PCCS hue wheel is a color system developed by Japan Color Research Institute.

For example, in a case where the light shielding portion 21 is yellow with the hue number=8, if the colored layer 30 is reddish yellow with the hue number=7, the colors are similar.

Furthermore, a state in which the colors are similar can also be expressed as a state in which the color difference is small. The color difference is an index representing a difference between two colors or colors of an object, and refers to, for example, a distance between coordinates of two colors when colors of two objects are applied to color coordinates in a three-dimensional color space such as an L*a*b color space, an RGB color space, and an XYZ color space. The color difference in each color space is determined by a color difference formula defined by the International Commission on Illumination (CIE). The state in which the colors are similar is a state in which a color difference is small and it is difficult to identify a color difference. Since the colors of the light shielding portion 21 and the colored layer 30 are similar or the color difference therebetween is small, it is possible to suppress the design of the design layer 20 from being seen through in a state where the light 40L is not emitted from the light source 40, and stealth property can be obtained.

### Sixth Modification Example

In the sixth modification example, it is different from the second embodiment in that the colored layer 30 is not provided and the protective layer 60 has a color.

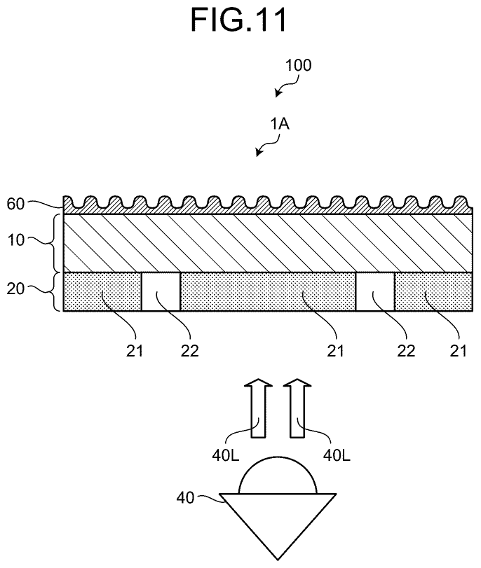

FIG. 11 is a schematic view illustrating a configuration of the light transmissive decoration system 100 including the light transmitting sheet 1A in which the protective layer 60 is colored and a colored layer 30 is not included according to the second embodiment of the present disclosure. As illustrated in FIG. 11, the protective layer 60 is colored, and also has an effect of imparting a color of the entire light transmitting sheet 1A. In addition, the protective layer 60 also has light-transmittance.

As a method of making the protective layer 60 colored, for example, a method of mixing a colorant in a paste-like resin by screen printing using a paste-like resin and forming the protective layer 60 with a resin material colored in advance is conceivable. Any method may be used as long as the colored protective layer 60 can be formed.

This makes it possible to reduce the process of printing the colored layer 30 and reduce the cost to create the light transmitting sheet 1A.

### Configuration and Effect of Second Embodiment

Hereinafter, the configuration of the second embodiment and the effects thereof will be described.

The light transmitting sheet 1A according to a second embodiment of the present disclosure includes the base material layer 10 that transmits light, the design layer 20 that includes the light transmitting portion 22 and the light shielding portion 21 on a back surface side of the base material layer 10, the back surface side being irradiated with the light 40L by the light source 40, the colored layer 30 that adjusts overall hue on a back surface side of the base material layer 10, and the protective layer 60 that complements at least one of abrasion resistance, hardness, chemical resistance, or light resistance of the base material layer 10 on a surface of the base material layer 10 on a side opposite to the back surface side of the base material layer 10. Among the surfaces of the protective layer 60, the surface of the protective layer 60 not in contact with the base material layer 10 has concavity and convexity 60a.

According to the above configuration, since the protective layer 60 is provided on the surface of the base material layer 10, reliability that is difficult to ensure by the material properties of the base material layer 10 is improved by providing the protective layer 60, and since the protective layer 60 has the concavity and convexity 60a, it is possible to obtain an appearance and a tactile sensation having an irregularity shape such as a woodgrain tone or leather. This makes it possible to obtain reliability and aesthetics for the user.

In the light transmitting sheet 1A, the protective layer 60 is formed to be thinner than the base material layer 10.

According to this configuration, since the protective layer 60 is thinner than the base material layer 10, even in a case where the protective layer 60 is provided, an elastic tactile sensation by the base material layer 10 can be obtained. As a result, the user can obtain a flexible feeling using the light transmitting sheet 1A.

In the light transmitting sheet 1A, a thickness t of the protective layer 60 is 0.05 mm<t<0.5 mm.

According to this configuration, since the thickness of the protective layer 60 is 0.05 mm or more and 0.5 mm or less, the protective layer 60 can have the concavity and convexity 60a and can obtain elasticity. As a result, the user can obtain a soft feeling and an aesthetic appearance of leather or woodgrain tone using the light transmitting sheet 1A.

In the light transmitting sheet 1A, the colored layer 30 is provided at a position closer to the base material layer 10 than the design layer 20 on the opposite side of the surface of the base material layer 10 on which the protective layer 60 is disposed.

According to this configuration, since the design layer 20 comes to the back surface side of the colored layer 30, it is possible to obtain stealth property in which the design layer 20 does not easily appear while coloring the front surface of the light transmitting sheet 1A by the colored layer 30. Therefore, in a case where the light 40L is not radiated, the design is less likely to come out, and the possibility that the user misrecognizes the information is suppressed.

In the light transmitting sheet 1A, the design layer 20 may be provided at a position closer to the base material layer 10 than the colored layer 30 on the opposite side of the surface of the base material layer 10 on which the protective layer 60 is disposed.

According to this configuration, since the colored layer 30 comes under the design layer 20, the light passing through the light transmitting portion 22 is not affected by the light diffusibility of the colored layer 30, the design is suppressed from being blurred on the surface of the light transmitting sheet 1A, and the visibility and the design property can be improved. Therefore, by displaying the color accurately, the user can appropriately interpret the information obtained through the color.

Furthermore, in the light transmitting sheet 1A, the colored layer 30 is configured such that the color difference between at least the color of the portion facing the light transmitting portion 22 and the light shielding portion 21 is equal to or less than a predetermined value.

According to this configuration, since the color difference between the color of at least the portion of the colored layer 30 facing the light shielding portion 21 and the color of the light shielding portion 21 is equal to or less than a predetermined value, it is possible to prevent the design from appearing and to obtain stealth property in a case where the light 40L is not radiated. Therefore, it is possible to further suppress the possibility that the user misrecognizes the information. In addition, it is possible to suppress the design from coming out and impairing the aesthetic appearance to the user in a case where the light 40L is not applied.

In addition, in the light transmitting sheet 1A, the base material layer 10 is an elastomer sheet.

According to this configuration, since the base material layer 10 is an elastomer sheet, the light transmitting sheet 1A can obtain elasticity, and can be used for a member to which pressure is applied.

Furthermore, the color shifting layer 50 that corrects the color of the light source 40 is further provided.

According to this configuration, since the color shifting layer 50 for correcting the color of the light is provided on the back surface side of the base material layer 10, the color of the light 40L displayed on the sheet surface changed by the influence of the colored layer 30 can be corrected by the color shifting layer 50. Therefore, by displaying the color of the light 40L more accurately, the user can appropriately interpret the information obtained through the color.

In addition, in the light transmitting sheet 1A, the transmission hole 30a that transmits light is provided in a portion facing the light transmitting portion 22 of the design layer 20, and the transmission hole 30a has a hole diameter smaller than a width of the light transmitting portion 22.

According to this configuration, since the small transmission hole 30a is opened in the portion of the colored layer 30 facing the light transmitting portion 22 of the design layer 20, the portion of the light 40L passing through the transmission hole 30a is not affected by the colored layer 30, and the transmission hole 30a has a hole diameter smaller than the width of the light transmitting portion 22, so that stealth property can be maintained. Therefore, in a case where the light 40L is not radiated, the design does not appear, and the possibility that the user misrecognizes the information is suppressed. In a case where the light 40L is radiated, the color of the light 40L is accurately displayed, and the intensity of the light 40L is not impaired, so that the user can accurately recognize the design and the information indicated by the design.

Furthermore, in the light transmissive decoration system 100, the color of the light 40L of the light source 40 is set to emit a target color by shifting the color in the colored layer 30.

According to this configuration, since the color of the light source 40 is set in consideration of the influence of the color received by the colored layer 30, as a result of the light 40L passing through the colored layer 30, a design can be displayed in a target color on the surface of the light transmitting sheet 1A. Therefore, by displaying the color accurately, the user can appropriately interpret the information obtained through the color.

In addition, in the light transmitting sheet 1A, the light shielding portion 21 has a transmittance of the light 40L of 5% or less.

According to this configuration, since the light shielding portion 21 hardly transmits the light 40L, the design can be appeared in the shape of the light transmitting portion 22. Therefore, the user can more accurately recognize the shape of the design.

In addition, in the light transmitting sheet 1A, the colored layer 30 has a transmittance of the light of 50% or more.

According to this configuration, since the colored layer 30 effectively passes the light 40L, the design of the light transmitting sheet 1A can be made to appear on the sheet surface with the light 40L.

### Third Embodiment

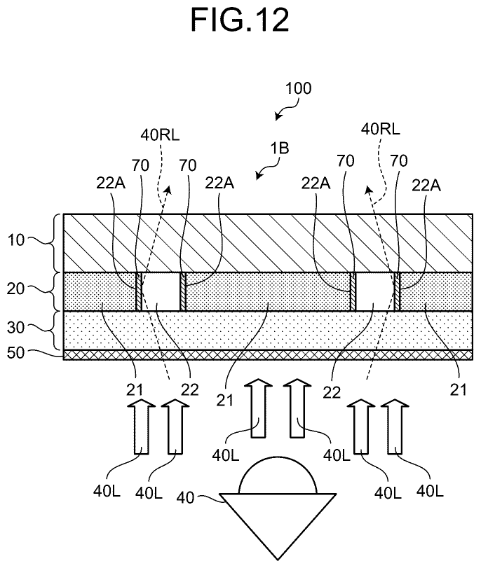

FIG. 12 is a schematic view illustrating a configuration of a light transmissive decoration system 100 including a light transmitting sheet 1B provided with a reflection layer according to a third embodiment of the present disclosure. The present embodiment is different from the first embodiment in that a reflection layer 70 is provided on an inner peripheral surface 22A of the light transmitting portion 22.

In the third embodiment, the same or equivalent configurations as those of the first embodiment or the second embodiment will be described with the same reference numerals. In addition, in the third embodiment, description overlapping with the first embodiment or the second embodiment may be omitted.

The light transmissive decoration system 100 includes the light transmitting sheet 1B and the light source 40. The light transmitting sheet 1B includes the base material layer 10, the design layer 20, and the colored layer 30. The base material layer 10, the design layer 20, and the colored layer 30 can be made of a sheet-like light transmitting material such as a resin film, a resin sheet, or a resin thin plate. Furthermore, it is possible to form the base material layer 10 from a sheet-like light transmitting material, and then bond the design layer 20 and the colored layer 30 to it, or to laminate them by a method such as printing.

On the back surface of the base material layer 10, the design layer 20 is provided adjacent to the base material layer 10. That is, the design layer 20 is provided at a position closer to the base material layer 10 than the colored layer 30.

As illustrated in FIG. 12, in the design layer 20, the light shielding portion 21 shields the light 40L from the light source 40, and the light transmitting portion 22 passes the light, so that a design of a character, a figure, a pattern, an icon, or a combination thereof appears in the shape of the light transmitting portion 22. Note that the light shielding portion 21 may form a design of a character, a figure, a pattern, an icon, or a combination thereof, and the shape of the light shielding portion 21 may appear on the surface as the light transmitting portion 22 transmits light.

It is conceivable that the design layer 20 be provided on the back surface of the base material layer 10 using a screen printing technique in which an ink is placed on a screen in which a portion (light transmitting portion 22) unnecessary for printing is solidified with an emulsion and the ink (light shielding portion 21) is transferred by rubbing with a squeegee. However, the present invention is not limited thereto. For example, the light transmitting portion 22 may be provided in a part by irradiating a film partially cut out in a design shape or a coated sheet member such as a coated film or a coated plate with a laser to form an opening (hole).

Since the design layer 20 is provided between the base material layer 10 and the colored layer 30, the light 40L emitted from the light source 40 passes through the colored layer 30, the design layer 20, and the base material layer 10 in this order. That is, since the light 40L that has passed through the light transmitting portion 22 is not affected by the light diffusibility of the colored layer 30, the outline of the design that should have passed through the shape of the light transmitting portion 22 and displayed on the surface of the light transmitting sheet 1B becomes clear.

In other words, by providing the design layer 20 between the base material layer 10 and the colored layer 30, the visibility of the design and the design property can be improved.

Furthermore, the reflection layer 70 is provided on the inner peripheral surface 22A of the light transmitting portion 22 of the design layer 20, that is, an interface between the light transmitting portion 22 and the light shielding portion 21.

The reflection layer 70 is formed of a material such as a metal thin film or a high reflectance paint (for example, white paint) by metal vapor deposition, and a surface of the reflection layer constitutes a reflection surface having a lower absorptivity of the light 40L and a higher reflectance than the material of the light shielding portion 21.

More specifically, the reflectance is preferably 90(%) or more with respect to the wavelength (wavelength range) of the light 40L.

As a result, the light 40L incident into the light transmitting portion 22 is reflected by the reflection layer 70 as reflected light 40RL and emitted from the base material layer 10, for example, as indicated by a broken line arrow in FIG. 12, and can be suppressed from being absorbed or attenuated by the light shielding portion 21.

That is, it is possible to suppress the loss of the amount of light passing through the light transmitting portion 22 in the light 40L radiated from the light source 40.

Therefore, when the design is made visible, even if the amount of the light 40L radiated from the light source 40 is the same, the amount of light passing through the light transmitting sheet 1B increases, and the user can more clearly view the design formed by the light transmitting portion 22.

In this case, since the inner peripheral surface 22A extends in the direction perpendicular to the surface viewed with respect to the base material layer 10, it is not easy to directly view the reflection layer 70. Therefore, in a case where the light source 40 does not emit the light 40L, the effect of making the boundary between the light transmitting portion 22 and the light shielding portion 21 of the design layer 20 inconspicuous, that is, the possibility of impairing the stealth property of the design when the light 40L is not radiated is reduced.

At this time, the transmittance of the light 40L of the light shielding portion 21 of the design layer 20 is preferably 5% or less. This is because the light shielding portion 21 suppresses the transmission of the light 40L, so that the design of the shape of the light transmitting portion 22 or the shape of the light shielding portion 21 can be appeared on the sheet surface.

### First Modification Example

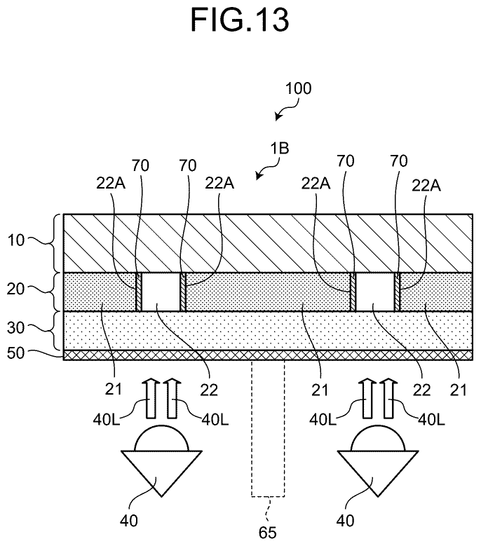

FIG. 13 is a schematic view illustrating a configuration of the light transmissive decoration system 100 including the light transmitting sheet 1B of the first modification example of the third embodiment.

In the third embodiment, the case where one light source 40 is arranged for the plurality of light transmitting portions 22 of the light transmitting sheet 1B has been described, but in the first modification example, the light source 40 is arranged for each of the light transmitting portions 22.

According to this configuration, by independently controlling each light source 40, each corresponding design can be independently appeared on the sheet surface in different modes (for example, one always lights up, the other blinks, and the like.).

In addition, according to this configuration, since the light amount of the light 40L radiated from each light source 40 may be set to a sufficient light amount with respect to each light transmitting portion 22, there is no need to provide a large light source 40.

In addition, it is also possible to configure such that the emission color is independently changed by using each light source 40 having different colors of the radiated light 40L or using a full-color LED capable of changing the emission color as the light source 40.

In this case, it is also possible to provide a partition 65 between both the light sources 40 as indicated by a broken line frame in FIG. 13 in order to prevent the light actually incident on each of the light transmitting portions 22 from mixing and becoming mixed in color. Alternatively, a partition wall may be provided to surround each of the light sources 40.

Furthermore, since the range of the light transmitting portion 22 corresponding to the light 40L is limited, it is possible to arrange the light transmitting portions closer than the distance between each light transmitting portion 22 and the light source 40, and it is also possible to further improve the visibility by effectively increasing the light amount.

In addition, the configuration of the first modification example can be similarly applied to the first embodiment and the second embodiment.

### Second Modification Example

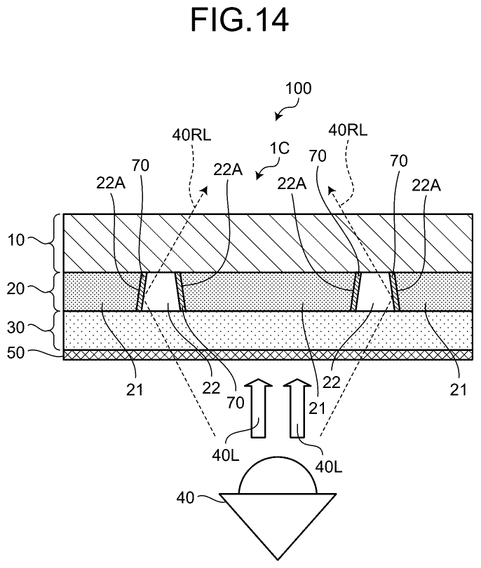

FIG. 14 is a schematic view illustrating a configuration of the light transmissive decoration system 100 including a light transmitting sheet 1C of the second modification example of the third embodiment.

In the third embodiment, the inner peripheral surface 22A of the light transmitting portion 22 of the light transmitting sheet 1C is formed perpendicular to the front surface and the back surface of the light transmitting sheet 1B, but in the second modification example, the inner peripheral surface 22A of the light transmitting portion 22 is formed in a tapered shape.

That is, the light transmitting sheet 1C of the second modification example is different from the light transmitting sheet 1B of the third embodiment in that the light shielding portion 21 is formed such that, in the shape of the light transmitting portion 22 in the surface of the design layer 20 viewed from the base material layer 10 side, an orthogonal projection with respect to a virtual plane parallel to the surface of the design layer 20 viewed from the base material layer 10 side falls within an orthogonal projection of the shape of the light transmitting portion 21 in the surface of the design layer 20 irradiated with the light 40L.

As a result, in a case where viewed from the base material layer 10 side of the design layer 20, it is possible to suppress the reflection surface (reflection layer 70) located at the boundary surface with the light shielding portion 21 of the light transmitting portion 22 from being visually recognized.

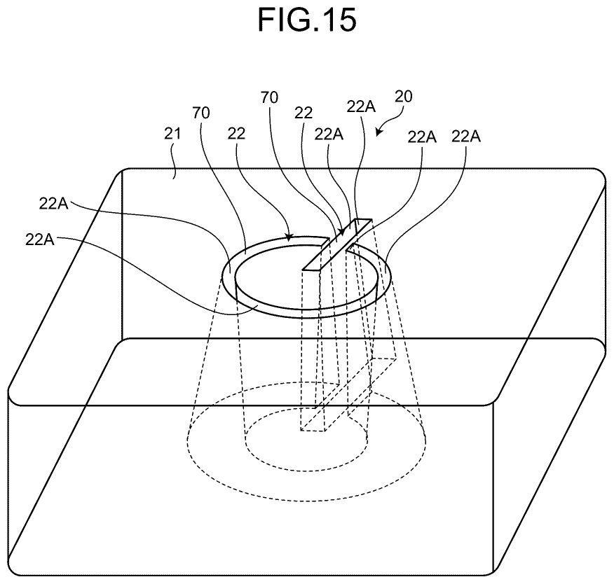

FIG. 15 is a perspective view of the design layer 20 of the light transmitting sheet 1C according to the second modification example of the third embodiment.

In the example of FIG. 15, the design illustrated in FIG. 3 is applied as the design.

As illustrated in FIG. 15, in the light transmitting sheet 1B of the second modification example, the light transmitting portion 22 is formed such that in the shape of the light transmitting portion 22 in the surface of the design layer 20 viewed from the base material layer 10 side, the orthogonal projection with respect to a virtual plane parallel to the surface of the design layer 20 viewed from the base material layer 10 side falls within an orthogonal projection of the shape of the light transmitting portion 22 in the surface of the design layer 20 irradiated with the light 40L.

As a result, the inner peripheral surface 22A of the light transmitting portion 22 is tapered as illustrated in FIG. 14.

As a result, it is not easy to directly visually recognize the reflection layer 70 on the inner peripheral surface 22A of the light transmitting portion 22.

Therefore, even in the second modification example, in a case where the light source 40 does not emit the light 40L, the effect of making the boundary between the light transmitting portion 22 and the light shielding portion 21 of the design layer 20 inconspicuous, that is, the possibility of impairing the stealth property of the design when the light 40L is not radiated is reduced.

Furthermore, according to the second modification example, since the opening area of the design on the surface of the light transmitting portion 22 on the base material layer 10 side is smaller than the opening area of the design on the surface of the light transmitting portion 22 on the colored layer 30 side, the light 40L incident from the colored layer 30 side is further condensed and emitted to the base material layer 10 side, and even in a case where the same light source 40 is used, brighter display than the first modification can be performed.

### Third Modification Example

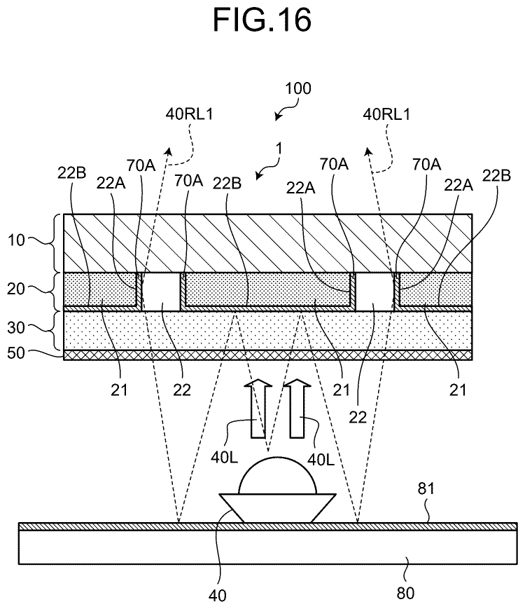

FIG. 16 is a schematic view illustrating a configuration of the light transmissive decoration system 100 including a light transmitting sheet 1D of a third modification example of the third embodiment. The light transmitting sheet 1D of the third modification example is different from the first modification example of the third embodiment in that the reflection layer 70A is provided not only on the inner peripheral surface 22A of the light transmitting portion 22 but also on the surface of the design layer 20 on the colored layer 30 side.

The light transmissive decoration system 100 includes the light transmitting sheet 1D, the light source 40, a substrate 80, and a substrate reflection layer 81.

The light transmitting sheet 1D includes the base material layer 10, the design layer 20, and the colored layer 30. The base material layer 10, the design layer 20, and the colored layer 30 can be made of a sheet-like light transmitting material such as a resin film, a resin sheet, or a resin thin plate. Furthermore, it is possible to form the base material layer 10 from a sheet-like light transmitting material, and then bond the design layer 20 and the colored layer 30 to it, or to laminate them by a method such as printing.

In the above configuration, a reflection layer 70A is provided on the inner peripheral surface 22A of the light transmitting portion 22 of the design layer 20, that is, on the interface between the light transmitting portion 22 and the light shielding portion 21 and an interface 22B between the design layer 20 and the colored layer 30.

Similarly to the above-described reflection layer 70, the reflection layer 70A is formed of a material such as a metal thin film or a high reflectance paint (for example, white paint) by metal vapor deposition, and a surface of the reflection layer constitutes a reflection surface having a lower absorptivity of the light 40L and a higher reflectance than the material of the light shielding portion 21.

More specifically, the reflectance is preferably 90(%) or more with respect to the wavelength (wavelength range) of the light 40L.

The light source 40 is mounted on the surface of the substrate 80 (the surface on the side corresponding to the colored layer 30), and the substrate reflection layer 81 is formed on the surface of the substrate 80.

Similarly to the reflection layer 70 described above, the substrate reflection layer 81 is also formed of a material such as a metal thin film or a high reflectance paint (for example, white paint) by metal vapor deposition, and a surface of the reflection layer constitutes a reflection surface having a lower absorptivity of the light 40L and a higher reflectance than the material of the light shielding portion 21.

As a result, similarly to the first modification example, the light 40L directly incident on the light transmitting portion 22 is, for example, reflected by the reflection layer 70A as the reflected light 40RL and emitted from the base material layer 10.

Furthermore, a part of the reflected light 40RL1 reflected by the reflection layer 70A provided at the interface 22B between the design layer 20 and the colored layer 30 is directed to the substrate 80 side, reflected by the substrate reflection layer 81 of the substrate 80, incident on the light transmitting portion 22, reflected by the reflection layer 70A provided on the inner peripheral surface 22A of the light transmitting portion 22 of the design layer 20, and emitted from the base material layer 10.

Therefore, the light 40L emitted from the light source 40 can be suppressed from being absorbed or attenuated by the light shielding portion 21. Further, a part of the light reflected by the substrate reflection layer 81 can be guided to the light transmitting portion 22.

That is, it is possible to suppress the loss of the amount of light passing through the light transmitting portion 22 in the light 40L radiated from the light source 40.

Therefore, when the design is made visible, even if the amount of the light 40L radiated from the light source 40 is the same, the amount of light passing through the light transmitting sheet 1D increases as compared with the first modification example, and the user can more clearly view the design formed by the light transmitting portion 22.

In also this case, since the inner peripheral surface 22A extends in the direction perpendicular to the surface viewed with respect to the base material layer 10, it is not easy to directly view the reflection layer 70A. Therefore, in a case where the light source 40 does not emit the light 40L, the effect of making the boundary between the light transmitting portion 22 and the light shielding portion 21 of the design layer 20 inconspicuous, that is, the possibility of impairing the stealth property of the design when the light 40L is not radiated is reduced.

Although the above description is a case where the substrate reflection layer 81 is provided on the substrate 80, even in a case where the substrate reflection layer 81 is not provided, the effect is reduced, but it is possible to suppress the attenuation of the light amount by the reflected light 40RL1 reflected by the substrate 80.

Although the above description has a configuration corresponding to the first modification example of the third embodiment, the tapered light transmitting portion 22 can be similarly applied as in the second modification example. Other Modification Examples

As other modification examples, similarly to the fourth modification of the first embodiment or the fourth modification example of the second embodiment, in the light transmitting sheet 1, the functional layer 68 may be provided between the layers.

Also in this case, as the functional layer 68, for example, an ultraviolet ray cutting layer, an adhesive layer for enhancing adhesion of each layer, and the like can be considered. The functional layer 68 can be formed using a general printing technique (screen printing, resin application method, or the like). Note that the functional layer 68 may be disposed closest to the light source 40 side.

### Configuration and Effects of Third Embodiment

Hereinafter, the configuration of the third embodiment and the effects thereof will be described.

The light transmitting sheet 1B according to a third embodiment of the present disclosure includes the base material layer 10 that transmits light, the design layer 20 that is provided to face a side of the base material layer 10 irradiated with light and has the light transmitting portion 22 and the light shielding portion 21, and the colored layer 30 that is provided to face the base material layer with the design layer 20 interposed therebetween, in which the design layer 20 includes the reflection layer 70 formed on a surface of the inner peripheral surface 22A as a boundary surface with the light transmitting portion 22 of the light shielding portion 21.

According to the above configuration, when light passes through the light transmitting portion 22, it is possible to suppress absorption or attenuation by the light shielding portion 21.

That is, it is possible to suppress the loss of the amount of light passing through the light transmitting portion 22 in the light 40L radiated from the light source 40.

Therefore, when the design is made visible, even if the amount of the light 40L radiated from the light source 40 is the same, the amount of light passing through the light transmitting sheet 1B increases, the user can more clearly view the design formed by the light transmitting portion 22 and the visibility of the design can be improved.

Therefore, the user can ascertain information accurately and quickly by clearly visually recognizing a design including information such as characters and symbols.

Furthermore, since the inner peripheral surface 22A extends in the direction perpendicular to the surface viewed with respect to the base material layer 10, it is not easy to directly view the reflection layer 70. Therefore, in a case where the light source 40 does not emit the light 40L, the effect of making the boundary between the light transmitting portion 22 and the light shielding portion 21 of the design layer 20 inconspicuous, that is, the possibility of impairing the stealth property of the design when the light 40L is not radiated is reduced.

Therefore, it is possible to prevent the user from erroneously recognizing that the design is displayed, and to appropriately present information to the user. In addition, since the decorative sheet can have a woodgrain tone, a leather pattern, or the like because the design cannot be seen while light is not transmitted, it is possible to impart an aesthetic appearance to the user.

In the light transmitting sheet 1C, the shape of the light transmitting portion 22 on the surface of the design layer 20 viewed from the base material layer 10 side is similar to the shape of the light transmitting portion 22 on the surface of the design layer 20 irradiated with light, and the shape of the light transmitting portion 22 on the surface of the design layer 20 irradiated with light is a shape obtained by enlarging the shape of the light transmitting portion 22 on the surface of the design layer 20 on the base material layer 10 side. Alternatively, the boundary surface of the light shielding portion 21 with the light transmitting portion 22 is formed in a tapered shape to extend from the base material layer 10 side toward the colored layer 30.

Therefore, when the design is made visible, even if the amount of light radiated to the light transmitting sheet 1C is the same, the amount of light passing through the light transmitting sheet 1C is further increased, and the user can more clearly view the design formed by the light transmitting portion 22.

In also this case, since the inner peripheral surface 22A extends in the direction perpendicular to the surface viewed with respect to the base material layer 10, it is not easy to directly view the reflection layer 70A. Therefore, in a case where the light source 40 does not emit the light 40L, the effect of making the boundary between the light transmitting portion 22 and the light shielding portion 21 of the design layer 20 inconspicuous, that is, the possibility of impairing the stealth property of the design when the light 40L is not radiated is reduced.

Therefore, it is possible to prevent the user from erroneously recognizing that the design is displayed, and to appropriately present information to the user. In addition, since the decorative sheet can have a woodgrain tone, a leather pattern, or the like because the design cannot be seen while light is not transmitted, it is possible to impart an aesthetic appearance to the user.

In addition, the light transmitting sheet 1D further includes the reflection layer 70A formed on a surface of the design layer 20 on the light source 40 side.

According to this configuration, the light reflected by the reflection layer 70A formed on the surface of the design layer 20 on the light source 40 side is further reflected by the component (for example, a substrate) provided at the position further facing the light transmitting portion 22, so that the light directed to the light transmitting portion 22 can be increased, and the visibility can be further improved. Other Modification Examples

Although the light transmitting sheet according to the present disclosure has been described above based on the above embodiments, the present disclosure is not limited to these exemplary embodiments. Various modifications conceived by those skilled in the art to the exemplary embodiments may be included in the scope of the present disclosure without departing from the gist of the present disclosure.

For example, in the above description, the light 40L from the light source 40 is configured to directly reach the light transmitting portion 22, but may be configured to reach the light transmitting portion 22 via a so-called light guide plate.

An example of the present disclosure provides a light transmitting sheet having improved visibility of a design.

Further advantages and effects in one example of the present disclosure will be apparent from the specification and drawings. Such advantages and/or effects are each provided by the features described in several embodiments and the specification and drawings, but not necessarily all provided to obtain one or more identical features.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A light transmitting sheet comprising:
a base material layer that transmits light;
a design layer provided to face a side of the base material layer irradiated with the light and having a light transmitting portion and a light shielding portion; and
a colored layer provided to face the base material layer with the design layer interposed therebetween.

2. The light transmitting sheet according to claim 1, wherein
the colored layer is configured such that at least a color of a portion facing the light transmitting portion is similar to the color of the light shielding portion.

3. The light transmitting sheet according to claim 2, wherein
a color difference ΔE between the colored layer and the light shielding portion is equal to or less than a predetermined value.

4. The light transmitting sheet according to claim 2, wherein
the light shielding portion has a light transmittance of 5% or less.

5. The light transmitting sheet according to claim 2, wherein
the base material layer has concavity and convexity on a surface of the base material layer.

6. The light transmitting sheet according to claim 2, wherein
the base material layer is an elastomer sheet.

7. The light transmitting sheet according to claim 2, further comprising a color shift layer that corrects a color of light and is provided to face a back surface of the base material layer, the back surface of the base material layer corresponding to a surface facing the colored layer and irradiated with the light.

8. The light transmitting sheet according to claim 2, wherein
the colored layer has a transmission hole that transmits light in a portion facing the light transmitting portion of the design layer, and
the transmission hole has a hole diameter smaller than a width of the light transmitting portion.

9. The light transmitting sheet according to claim 2, wherein
a color of the light is set to a predetermined color by shifting a color in the colored layer.

10. The light transmitting sheet according to claim 1, further comprising:
a protective layer provided to face a surface of the base material layer opposite to the side of the base material layer irradiated with the light, the protective layer complementing at least one of abrasion resistance, hardness, chemical resistance, or light resistance of the base material layer, wherein
a surface of the protective layer opposite to a surface facing the base material layer has concavity and convexity.

11. The light transmitting sheet according to claim 10, wherein
the protective layer is formed to be thinner than the base material layer.

12. The light transmitting sheet according to claim 11, wherein
a thickness t of the protective layer is 0.05 mm<t<0.5 mm.

13. The light transmitting sheet according to claim 10, wherein
the design layer is provided to face a surface of the base material layer opposite to a surface on which the protective layer is provided, at a position closer to the base material layer than the colored layer.

14. The light transmitting sheet according to claim 10, wherein
the colored layer is provided to face a surface of the base material layer opposite to a surface on which the protective layer is provided, at a position closer to the base material layer than the design layer.

15. The light transmitting sheet according to claim 14, wherein
the colored layer is configured such that at least a color of a portion facing the light transmitting portion has a color difference equal to or less than a predetermined value from a color of the light shielding portion.

16. The light transmitting sheet according to claim 10, further comprising a color shift layer that corrects a color of light.

17. The light transmitting sheet according to claim 1, wherein
the design layer includes a reflection layer formed at a boundary surface between the light shielding portion and the light transmitting portion.

18. The light transmitting sheet according to claim 17, wherein
the light transmitting portion is formed such that an orthogonal projection with respect to a virtual plane parallel to a surface of the design layer viewed from the base material layer in a shape of the light transmitting portion in the surface of the design layer viewed from the base material layer falls within an orthogonal projection of the shape of the light transmitting portion in a surface of the design layer irradiated with the light.

19. The light transmitting sheet according to claim 17, wherein
a boundary surface between the light shielding portion and the light transmitting portion is formed in a tapered shape to extend from the base material layer toward the colored layer.

20. The light transmitting sheet according to claim 17, further comprising:
a reflection layer formed on a surface of the design layer opposite to a surface facing the base material layer.
